(19) United States
(12) Patent Application Publication
(10) Pub. No.: US 2019/0126965 A1
(43) Pub. Date: May 2, 2019

(54) MOBILE DEVICE HOLDER

(71) Applicant: Walmart Apollo, LLC, Bentonville, AR (US)

(72) Inventors: Yurgis Mauro Bacallao, Centerton, AR (US); Joel Larson, Rogers, AR (US)

(21) Appl. No.: 16/150,309

(22) Filed: Oct. 3, 2018

Related U.S. Application Data
(60) Provisional application No. 62/578,967, filed on Oct. 30, 2017.

(51) Int. Cl. B62B 3/14; H04M 1/04; H04B 1/3877

(52) U.S. Cl. CPC B62B 3/1472; H04B 1/3877; H04M 1/04

(57) ABSTRACT

An apparatus for holding two different mobile devices on a shopping cart comprises a frame portion that extends horizontally and includes a perimeter that forms an interior region for receiving at least one of the two different mobile devices; a first opening in the interior region for receiving a handle of one of the two different mobile devices; at least one second opening for providing a line of sight view from a sensor in each of the two different mobile devices; a base portion that extends from a bottom region of the frame portion; and a removable coupling mechanism that extends between the base portion, and is constructed and arranged for coupling to a shopping cart.

### CROSS REFERENCE TO RELATED APPLICATIONS

This application claims the priority and benefit of U.S. Application No. 62/578,967 entitled “Mobile Device Holder” filed Oct. 30, 2017, the contents of which are hereby incorporated by reference.

### FIELD OF THE DISCLOSURE

The present disclosure relates generally to retail shopping applications, and more specifically to an apparatus for coupling different mobile devices to a shopping cart.

### BACKGROUND

Mobile computing devices are carried by most people, and in some store environments are an integral part of a shopping trip. Customers often use a shopping cart or other wheeled device for carrying items to be purchased during the shopping trip. It can be difficult to hold and operate the mobile computing device and push the shopping cart at the same time.

Some stores provide a mobile electronic device such as a Motorola MC18 mobile computing device for a shopper to use to perform functions otherwise performed by a store associate, such as scanning universal product code (UPC) barcode labels, self-checkout, and so on. However, a personal mobile computing device such as a smartphone may also be used, for example, to store shopping lists or electronic coupons, perform point of sale (POS) transactions, and so on. Thus, either the store-provided or user-provided mobile computing device may be used, each requiring an interface to the shopping cart so that the shopper can operate the respective device in a hands-free manner while pushing the shopping cart.

### SUMMARY

In one aspect, provided is an apparatus for holding two different mobile devices on a shopping cart, comprising: a frame portion that extends horizontally and includes a perimeter that forms an interior region for receiving at least one of the two different mobile devices; a first opening in the interior region for receiving a handle of one of the two different mobile devices; at least one second opening for providing a line of sight view from a sensor in each of the two different mobile devices; a base portion that extends from a bottom region of the frame portion; and a removable coupling mechanism that extends between the base portion, and is constructed and arranged for coupling to a shopping cart.

In some embodiments, the two different mobile devices include a smartphone and a handheld barcode scanner, wherein the handle of the one of the two different mobile devices is part of the handheld barcode scanner.

In some embodiments, the handheld barcode scanner includes the handle received by the first opening in the interior region.

In some embodiments, the frame portion is rectangular, the first opening includes a round or oval hole, and the at least one second opening includes three holes for a combination of line of sight viewing by a scanner of the two different mobile devices and access to the interior region.

In some embodiments, the apparatus further comprises at least one third opening including a drain hole at an opposite end of the frame portion as the at least one second opening.

In some embodiments, the frame portion includes a sidewall having a first region of a first height aligned with at least one opening, a second region having an indent of a second height aligned with the first opening, and a support edge of a third height than the first and second heights aligned with the at least one third opening.

In some embodiments, the apparatus further comprises a corner stop positioned over at least a portion of the at least one third opening for holding the mobile devices in place in the interior.

In some embodiments, the coupling mechanism is a universal coupling mechanism, and is constructed and arranged for coupling a different apparatus to the shopping cart.

In some embodiments, the coupling mechanism comprises a support bracket that extends between the base portion and the shopping cart; a backup plate parallel to and applying a force in a direction of a distal end of the support bracket; and a set of threaded elements extending from the backup plate for coupling to the support bracket.

In another aspect, an apparatus for holding two different mobile devices on a shopping cart comprises a frame portion that extends horizontally and includes a perimeter that forms an interior region for receiving at least one of the two different mobile devices; a first opening in the cavity for receiving a handle of one of the two different mobile devices; a second opening for providing a line of sight view from a sensor in each of the two different mobile devices; a base portion that extends vertically from the horizontal frame portion for coupling to a wire back base frame of the shopping cart; and a cross-bar that extends from a sidewall of the horizontal frame portion to the vertical base portion.

In some embodiments, the two different mobile devices include a smartphone and a handheld barcode scanner, wherein the handle of the one of the two different mobile devices is part of the handheld barcode scanner.

In some embodiments, the frame portion is rectangular, the first opening includes a round or oval hole, and the at least one second opening includes three holes for a combination of line of sight viewing by a scanner of the two different mobile devices and access to the interior region.

In some embodiments, the frame portion includes a sidewall having a first region of a first height aligned with at least one opening, a second region having an indent of a second height aligned with the first opening, and a support edge of a third height than the first and second heights aligned with the at least one third opening.

In some embodiments, the apparatus further comprises a universal coupling mechanism that is constructed and arranged for coupling a different apparatus to the shopping cart.

In some embodiments, the coupling mechanism comprises a support bracket that extends between the base portion and the shopping cart; a backup plate parallel to and applying a force in a direction of a distal end of the support bracket; and a set of threaded elements extending from the backup plate for coupling to the support bracket.

In another aspect, a method for coupling two mobile computing devices to a shopping cart, each of the two mobile computing devices having a different structural configuration, comprises coupling a mobile device holder to the shopping cart; and positioning at least one of the first mobile computing device or a second mobile computing device in the mobile device holder, the first mobile computing device having a handle, the second mobile computing device having a different configuration than the first mobile computing device.

In some embodiments, the method further comprises replacing one of the first and second mobile computing devices with the other of the first mobile computing device or a second mobile computing device.

In some embodiments, one and only one of the first and second mobile computing devices is positioned in the mobile device holder.

### BRIEF DESCRIPTION OF THE DRAWINGS

Exemplary embodiments will now be described, by way of example only, with reference to the following drawings, in which:

FIG. 1 is a perspective view of a mobile device holder, in accordance with some embodiments.

FIG. 2 is a perspective view of the mobile device holder of FIG. 1 coupled to a shopping cart.

FIG. 3 is front perspective view of the mobile device holder of FIGS. 1 and 2.

FIG. 4 is a closeup perspective view of an interior of the mobile device holder of FIGS. 1-3, in accordance with some embodiments.

FIG. 5 is a bottom perspective view of the mobile device holder of FIGS. 1-4, in accordance with some embodiments.

FIG. 6 is a side perspective view of a universal coupling mechanism, in accordance with some embodiments.

FIG. 7 is an exploded view of the universal coupling mechanism of FIG. 6.

FIG. 8A is a perspective view of the universal coupling mechanism of FIGS. 6 and 7 coupling the mobile device holder of FIGS. 1-5 to a shopping cart.

FIG. 8B is a closeup perspective view of the universal coupling mechanism of FIGS. 6-8A.

FIG. 9A is a perspective view of a handheld scanning device separate from a universal mobile device holder, in accordance with some embodiments.

FIG. 9B is a perspective view of the handheld scanning device securely and removably positioned in the universal mobile device holder of FIG. 9A.

FIG. 10A is a perspective view of a smartphone separate from the universal mobile device holder of FIGS. 9A-10A, in accordance with some embodiments.

FIG. 10B is a perspective view of the smartphone securely and removably positioned in the universal mobile device holder of FIG. 10A.

FIG. 11 illustrates a method of coupling two different mobile computing devices to a shopping cart, in accordance with some embodiments.

### DETAILED DESCRIPTION

Described are embodiments of a universal mobile device holder for coupling different mobile electronic device, also referred to as a mobile device, to a shopping cart. Examples of a mobile electronic device may include but not be limited to a cellular telephone, tablet or notebook computing device, calculator, scanner, music, video, or multimedia device, or other device having a computer processor. In some embodiments, the holder may hold non-computing devices such as a notepad or voice recorder, or other item having dimensions configured for positioning in the holder.

The mobile device holder is constructed and arranged for allowing a user to push a shopping cart while controlling the mobile device attached via the holder to the shopping cart. Although shopping carts are described, the mobile device holder may be constructed and arranged for removably coupling to a handle or rail of a shopping object or other fixed tubular or elongated element. The mobile device holder may be provided by the retail store to the customer, or alternatively, can be owned by the customer and brought into the store for use in the store by the customer.

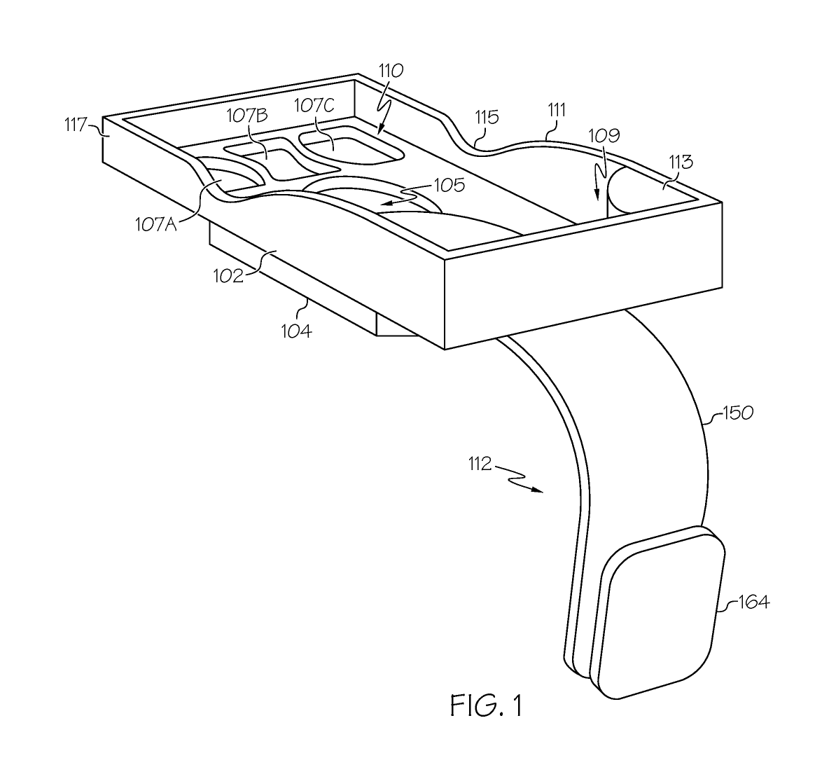

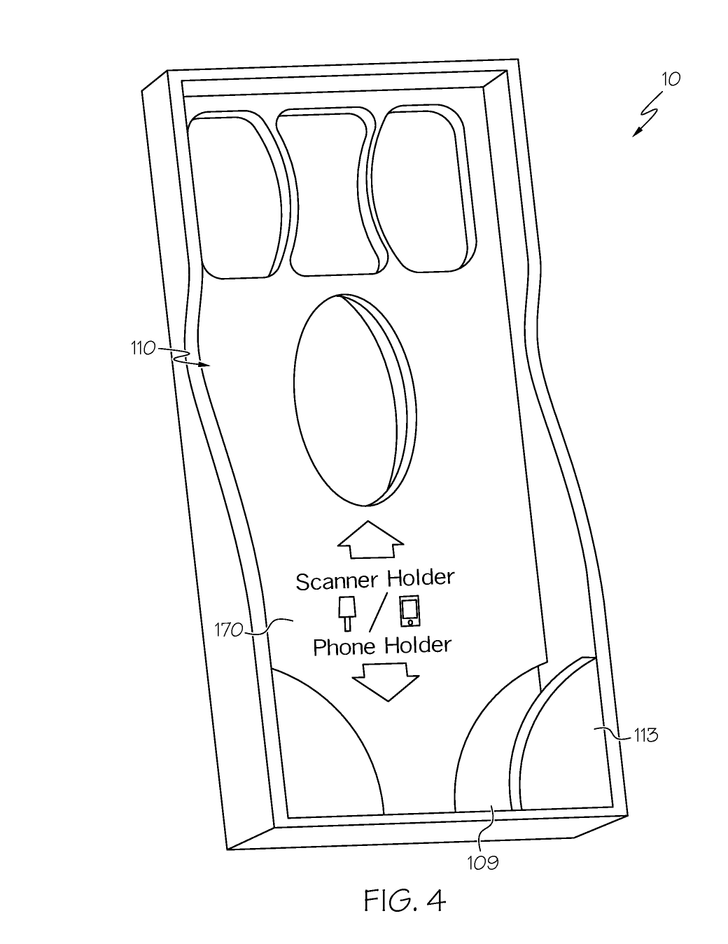

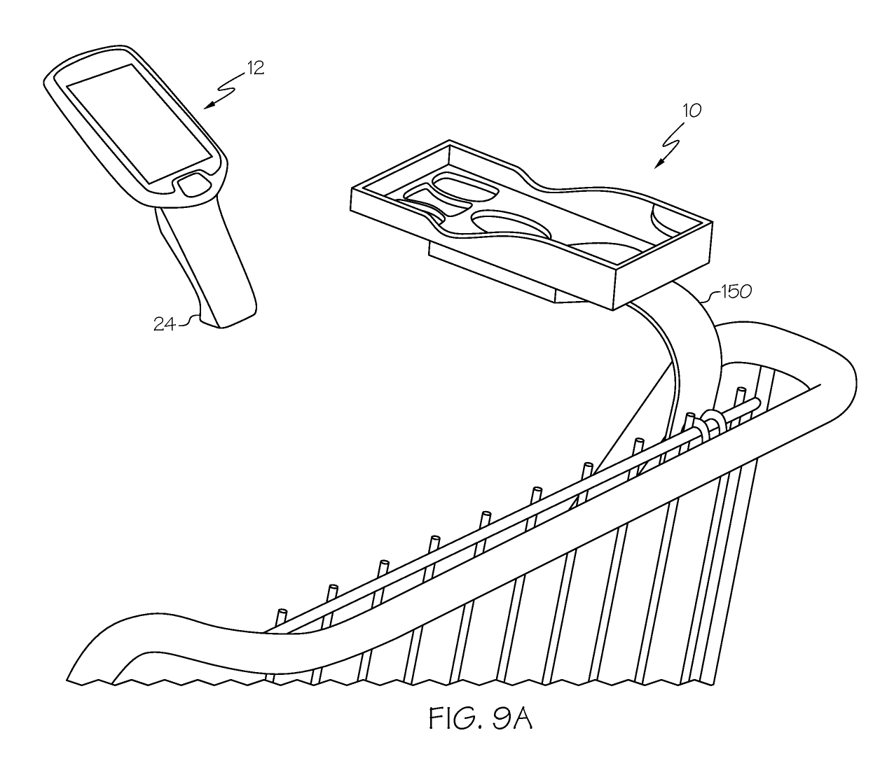

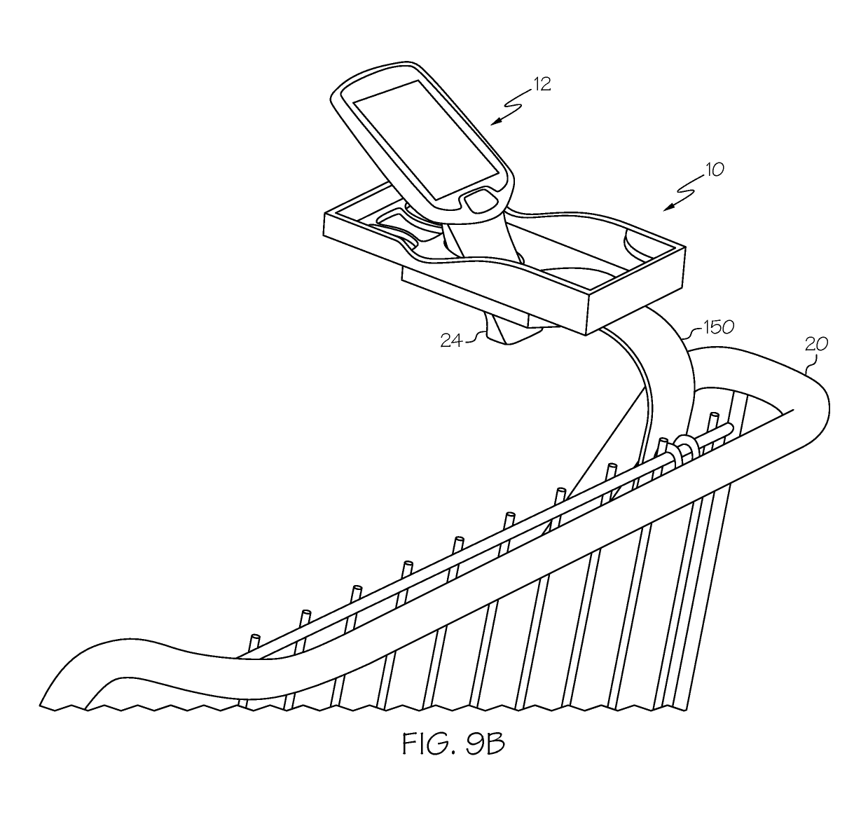

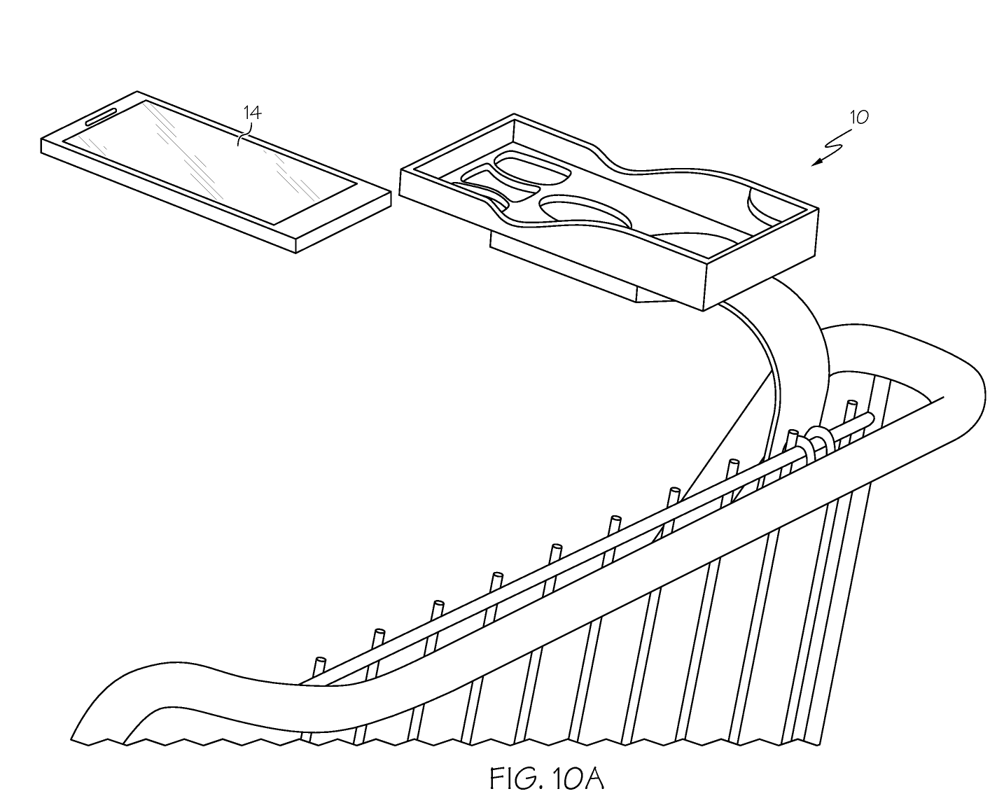

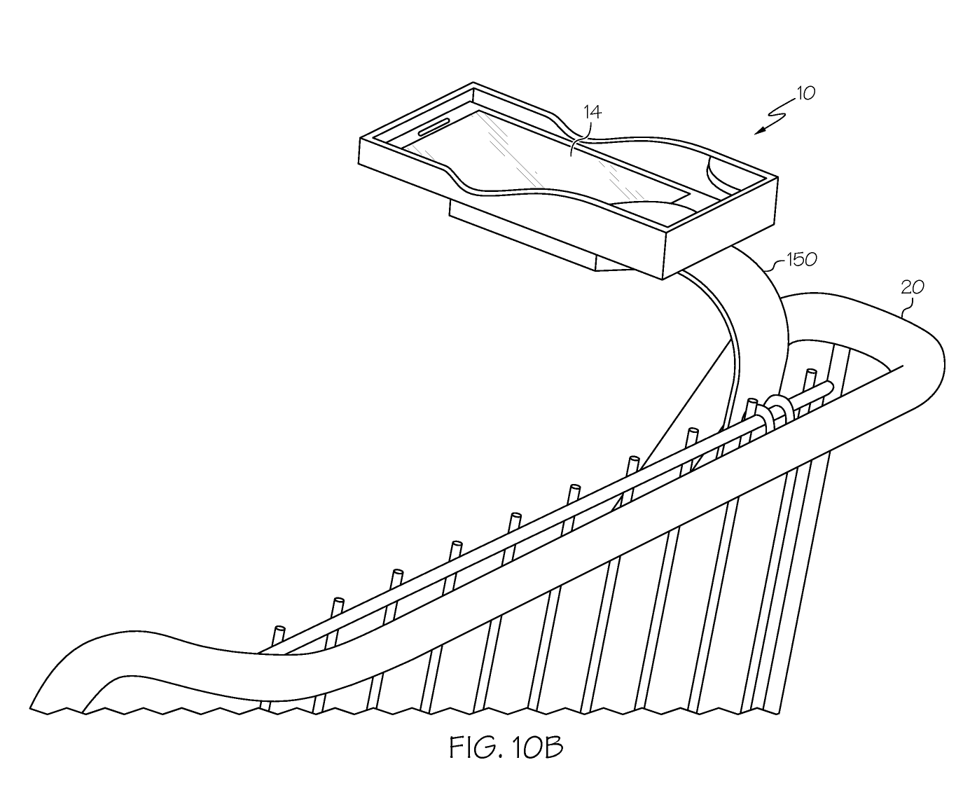

In some embodiments, as shown in FIGS. 1-5, a mobile device holder 10 comprises a frame portion 102, an interior 110 of the frame portion 102 having a plurality of openings that extends horizontally and includes a perimeter that forms an interior region for receiving at least one of the two different mobile devices, and a base portion 104 that extends from a bottom region of the frame portion 102 for providing a coupling to a shopping cart 20. The mobile device holder 10 may also include a coupling mechanism 150 removably coupled to the base portion 104 for coupling to a handle or wire back base frame of a shopping cart 20, or a shopping basket, or other apparatus for carrying groceries or other items for purchase by a store customer. In some embodiments, a shopping cart 20 can be a smart shopping cart with communication and power capability. Here, the holder 10 can serve as an interface between the mobile device, for example, a mobile electronic scanning device 12 shown in FIGS. 9A and 9B or smartphone 14 shown in FIGS. 10A and 10B, and other shopping accessories such as other input/output devices, power charging devices, or other electrical and/or mechanical accessories.

Some or all of the frame portion 102 and base portion 104 may be molded, machined, or otherwise formed of a recyclable material such as nylon plastic, polylactide (PLA), or other biodegradable polymer material. In some embodiments, the plastic forming the the frame portion 102 and base portion 104 may include germ-free and/or self-sterilizing material. In some embodiments, the frame portion 102 and base portion 104 are unitary, or one-piece, an molded or machined of a common source of material In other embodiments, the frame portion 102 and base portion 104 are formed separately, and coupled together using adhesives, screws, and so on.

In other embodiments, the base 104 extends at an angle from the frame portion 102, and the mobile device holder 10 comprises a crossbar (not shown) extending between the frame portion 102 and base 104, for example, at an angle, for additional rigidity. In some embodiments, the crossbar extends from a side of the frame portion 102 or base 104, for example, directly under or proximal a lip or perimeter of the frame 102 to a mid-region of the base 104 or coupling mechanism 150 to provide stability to the holder 10, since the joint or region of intersection between the frame 102 and base 104 may otherwise be fragile or prone to damage when a force is applied. In addition, the location of the crossbar may permit a mobile device handle 24 to extend through the opening 105 in the frame 102 without interference or blockage, and also allowing the user to access the handle 24, e.g. buttons on the handle 24, without interference by the crossbar. In some embodiments, a region of space may be between the frame 102, base 104, and crossbar. In other embodiments, this region may be solid and formed of a same material as, and unitary with, the frame 102, base 104, and crossbar to provide further stability. This region may be used to attach or otherwise display text, graphics, or other visual information, for example, advertising material.

In some embodiments, the frame portion 102 has a square, rectangle, or other polygon shape. Each side of the polygon-shaped frame portion 102 may include a lip, which collectively form a perimeter about interior region 110, or cavity or the like, of the frame portion 102 that provide a dual purpose of holding either a smartphone 14 or other personal mobile computing device or a scanning device 12 or the like having a handle. The corners of the lip perimeter are preferably rounded to reduce the risk of user injury otherwise caused by sharp edges. In other embodiments, as shown in FIGS. 1-5, the frame portion 102 does not include a lip, and the smartphone or other personal mobile computing device or a handheld scanning device or the like may nevertheless be positioned in the interior region 110 of the frame portion 102 during operation.

The interior region 110 is constructed and arranged to receive and temporarily hold in two or more different mobile electronic devices, one of which may include a Motorola MC18 mobile computing device 12 or the like, and the other being a smartphone computing device 14 or the like, which may execute a point of sale (POS) function and/or other function such as presenting electronic shopping lists, providing store navigation tools, and so on. Many physical differences may exist between mobile electronic devices. For example, the scanning device 12 may include a handle 24 (see FIGS. 9A and 9B). However, a typical smartphone 14 (see FIGS. 10A and 10B) has a flat back surface. Other differences may exist such as length, width, thickness, screen size, camera, sensor, or barcode scanner location, and so on. For example, the interior region 110 may accommodate the scanning device 12 having a particular set of dimensions, for example, 8 inches long×3 inches wide×3 inches high or depth (including handle). The interior region 110 may also accommodate a different device such as the smartphone 14 shown in FIGS. 10A and 10B having a different set of dimensions, for example, 5.6 inches long×3.0 inches wide×0.3 inches depth. Other dimensions, shapes, and/or configurations may equally apply that accommodate multiple mobile electronic devices, regardless of whether the mobile electronic device has a handle.

With further regard to the scanning device 12, the scanning device 12 when positioned in the mobile device holder 10 can allow store customers to scan items as they shop, allowing for a faster checkout. The scanning device 12 may alternatively be used by store associates, for example, to perform price audits, price checks, and inventory management. The scanning device 12 may include a barcode scanner or the like and a touch display, which are accessible, viewable, and/or otherwise operable when the scanning device 12 is positioned in the holder 10.

The interior region 110 includes a first opening 105 and a second opening 107. The first opening 105 may be configured to receive and permit the extension therethrough of a handle or related elongated element of a mobile electronic device. For example, the first opening 105 may have a round or oval shape, or other shape, allowing for the insertion of the handle 24 or related elongated element of a handheld electronic scanning device. The first opening 105 has a configuration, e.g., shape, which permits a user to operate the handle 24. For example, the scanning device handle 24 may have a push button, switch, trigger, or the like that requires accessibility by a user when the handheld scanning device 12 is inserted into the mobile device holder 10 and positioned in the interior region 110 whereby the handle 24 extends through the first opening 105 and is exposed below the frame portion 102. In other embodiments, the opening 105 may receive a cable or the like for coupling the mobile device 12 to a charging pad, computer device, electrical connector, docking station, or other apparatus.

The interior region 110 preferably has a flat surface that mates with a bottom surface of the scanning device 12 in a manner that reduces or prevents undesirable motion of the device 12, especially the handle 24 of the device 12, during movement of the shopping cart or other apparatus to which the mobile device holder 10 is attached. The interior region 110 may also mate with the bottom surface of smartphone 14 shown in FIGS. 10A and 10B.

The second opening 107 is constructed and arranged to provide a line of sight view from a sensor in each of the two different mobile devices through the second opening 107 to an object of interest, such as a barcode label. Modern display-based mobile devices typically have a camera or other sensor at a surface opposite a display surface so that a user may view from the display a field of view of the camera or other sensor. It follows that at least one second opening 107A-C aligns with the camera or other sensor while the interior region 110 is exposed so that the user can view the device display. The frame portion 102 is oriented in a horizontal position so that the mobile device sensor faces a downward direction, for example, at an object between the frame portion 102 and the ground.

In some embodiments, a plurality of second openings 107A, 107B, 107C (generally, 107) are provided. Here, one hole such as center hole 107B may align with a mobile device camera or the like, and the side holes 107A, 107B may be used for easy access to the interior 110 from underneath the holder 10 for cleaning, removal of the mobile device from the interior 110, e.g., inserting a finger through the hole 107 for applying a force against the back surface of the mobile device, and so on. As described herein, a sensor of a smartphone or the like, such as a camera but not limited thereto, may be positioned over one or more openings 107 which provide a line-of-sight for the sensor. In other embodiments, smaller mobile devices may be positioned in the holder 10 but may not be positioned over the holes 107. The holes 107 may therefore be available for other purposes, for example, to hold a tubular object which is positioned through the hole 107 and coexist with the smaller mobile device in the holder 10.

In some embodiments, the mobile device holder 10 includes third openings 109A, 109B (generally, 109) at corners of the interior region 110 opposite the second openings 107. The third openings 109 may be drain holes. In particular, the drain holes 109 may allow fluid, debris, cleaning liquid, and so on to be removed from the interior region 110, and to also allow access to the portion of the interior region near the drain holes 109 from a finger, an elongated object such as a brush, and so on in order to clean the interior region 110. The second openings 107 may provide a similar function, except for an opposite end of the interior region 110 as the drain holes 109. The mobile device holder 10 may also include a corner stop 113 positioned over at least a portion of each third opening 109 for holding the mobile device in place, for example, in lieu of a frame perimeter lip. In some embodiments, the bottom surface of the interior region may be tapered so that fluid drains in a direction away from the second openings 107 and toward the third openings 109.

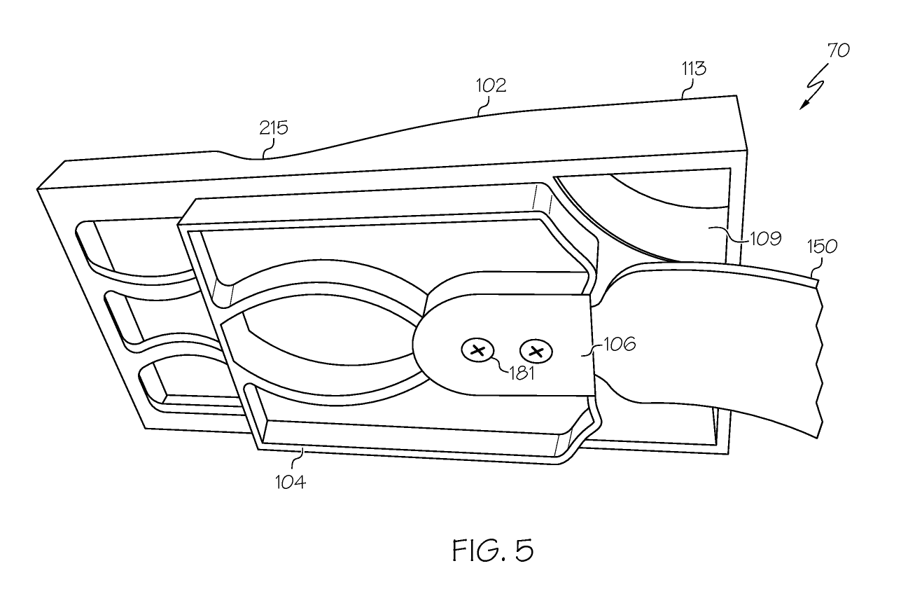

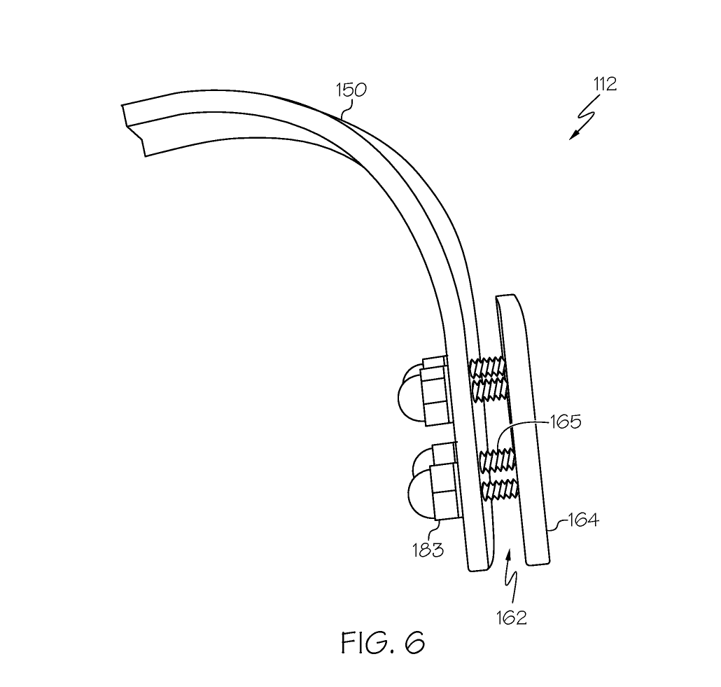

In some embodiments, the base portion 104 includes a slot 106 or the like for receiving a support bracket 150 of the coupling mechanism 150 that extends between the mobile device holder 10 and a shopping cart handle or other elongated object such as a wire frame, rod, bar, or rail extending from a shopping cart, basket, or other apparatus for transporting store items. The support bracket 150 is preferably formed of metal, but not limited thereto. The support bracket 150 may have a curved shape for achieving a desired orientation, distance, or other position of the holder 10 relative the shopping cart 20. One end of the support bracket 150 is inserted into the base portion slot, and held in place by screws 203, or clips or other coupling elements. The other end of the bracket 150 includes a backup plate 164 that is coupled to the end of the bracket 150 with four screws or other coupling elements, for example, shown in FIG. 5. As shown in FIG. 6, a gap 162 between the bracket 150 and backup plate 164 may be positioned over an elongated object such as a top rail of a shopping cart.

The frame portion 102 may include sidewalls that form the interior region 110. In some embodiments, the frame portion sidewalls may be of a uniform height extending from the bottom surface through which the openings 105, 107, and 109 extend. This uniform height may be higher than a height of a mobile device positioned in the interior region 110. In other embodiments, as shown in FIG. 1, the frame portion sidewalls may be of different heights at various regions. For example, the frame portion sidewalls may include an indent region 115, for example, at a mid-section of the frame portion 102, so that a user can directly grab the mobile device positioned in the interior region 110 without interference from other sidewall regions 111, 117, which would otherwise be higher than the mobile device making it difficult for the user to remove the mobile device from the interior region 110. One of the other regions includes mobile a support edge 111 in addition to the indent region 115. The support edge 111 may be of a height that is greater than both the indent region 115 and the other sidewall portions of the frame portion 102. The corner stops 113 may extend from the support edge 111 over at least a portion of the third openings 109. In some embodiments, the sidewall 117 of a first height aligns with the second openings 107 at a top region of the mobile device holder 10, the indent region 115 of a second height aligns with the first opening 105 at a mid-region of the mobile device holder 10, and the support edge 111 of a third height than the first and second heights aligns with the third openings 109 at a bottom region of the mobile device holder 10.

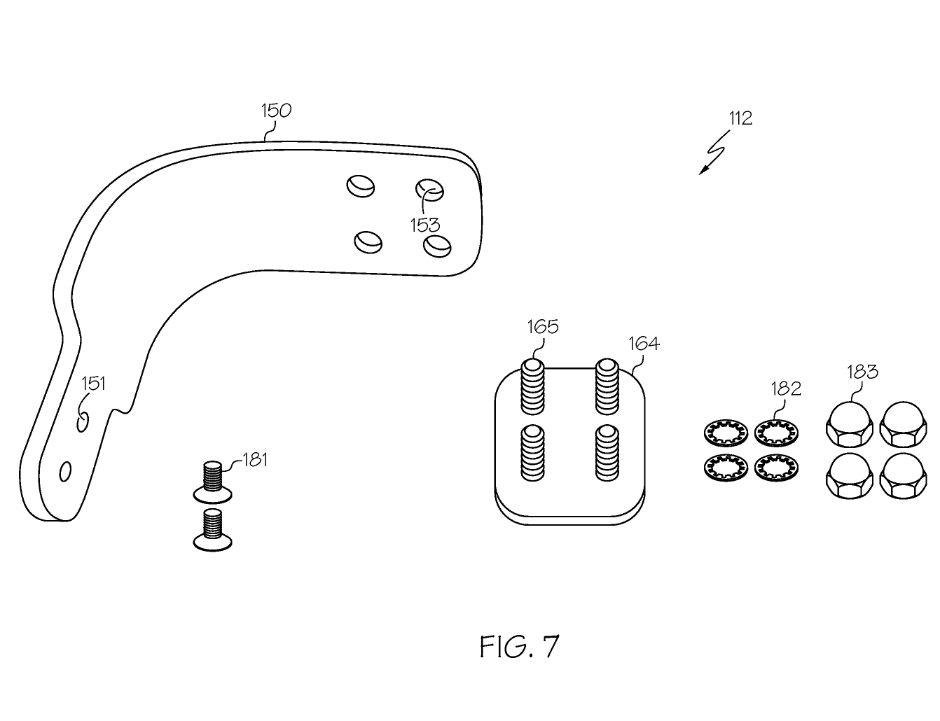

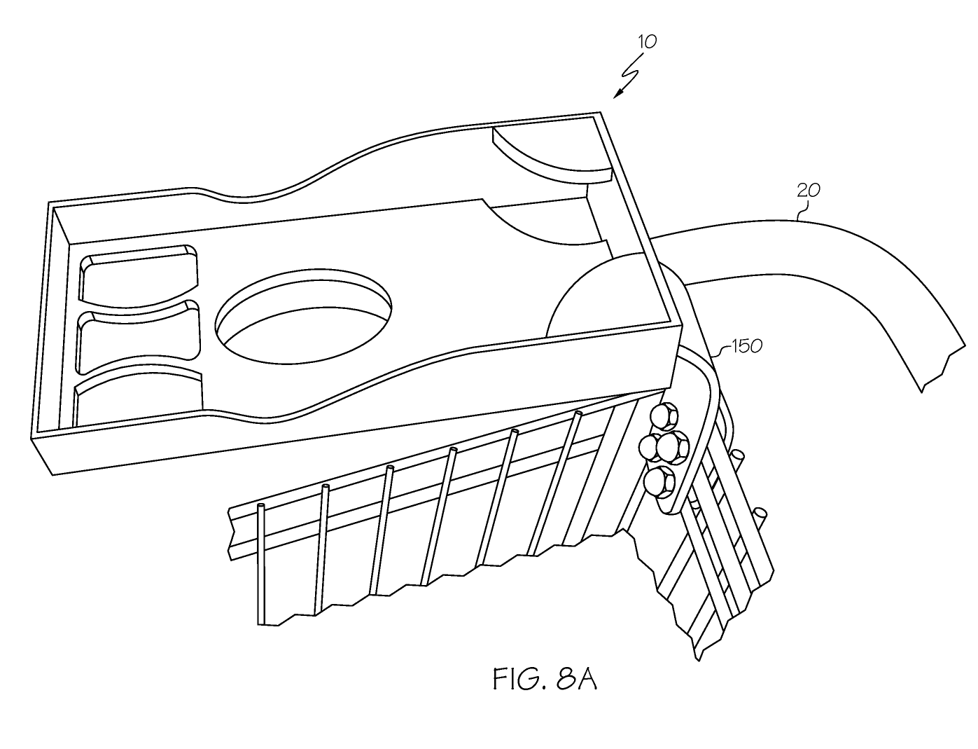

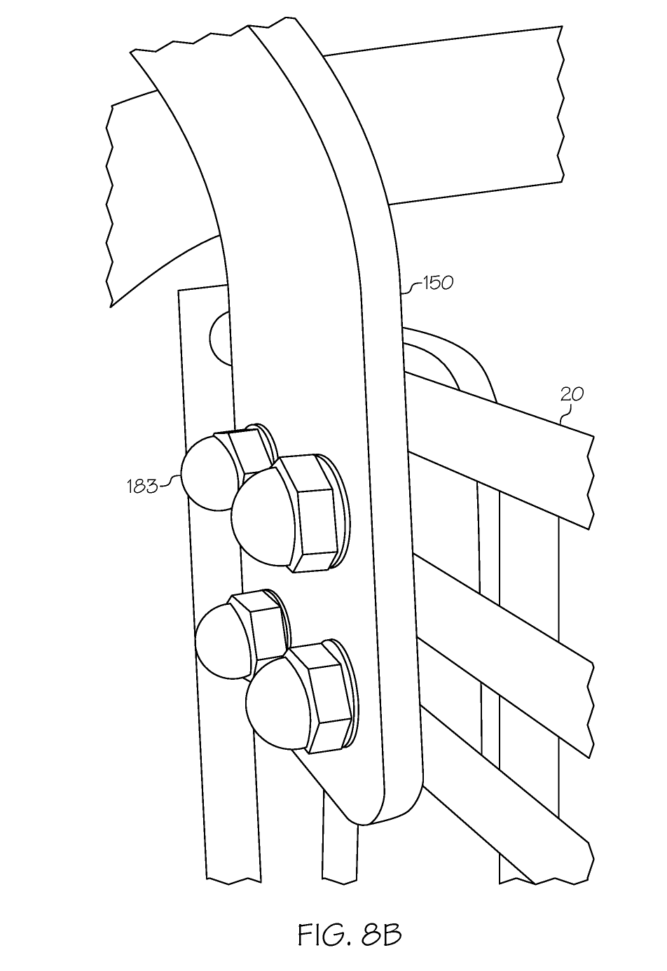

As previously described, the coupling mechanism 150 may include a support bracket 150 and a backup plate 164. As shown in FIGS. 5-8B the coupling mechanism 150 may also include accessories 181, 182, 183 that permit the coupling mechanism to be a universal coupling mechanism, for example, coupling to devices other than the device holder 10. The accessories may include at least two screws 181 or related coupling elements for removably coupling a proximal end of the support bracket 150 to the holder 10. In particular, the proximal end of the support bracket 150 may be inserted in the slot 106 of the base 104. The slot 106 includes holes that align with holes 151 in the proximal end of the support bracket 150. The screws 181 or related coupling elements are inserted through the holes for securely holding the support bracket 150 in place in the base 104.

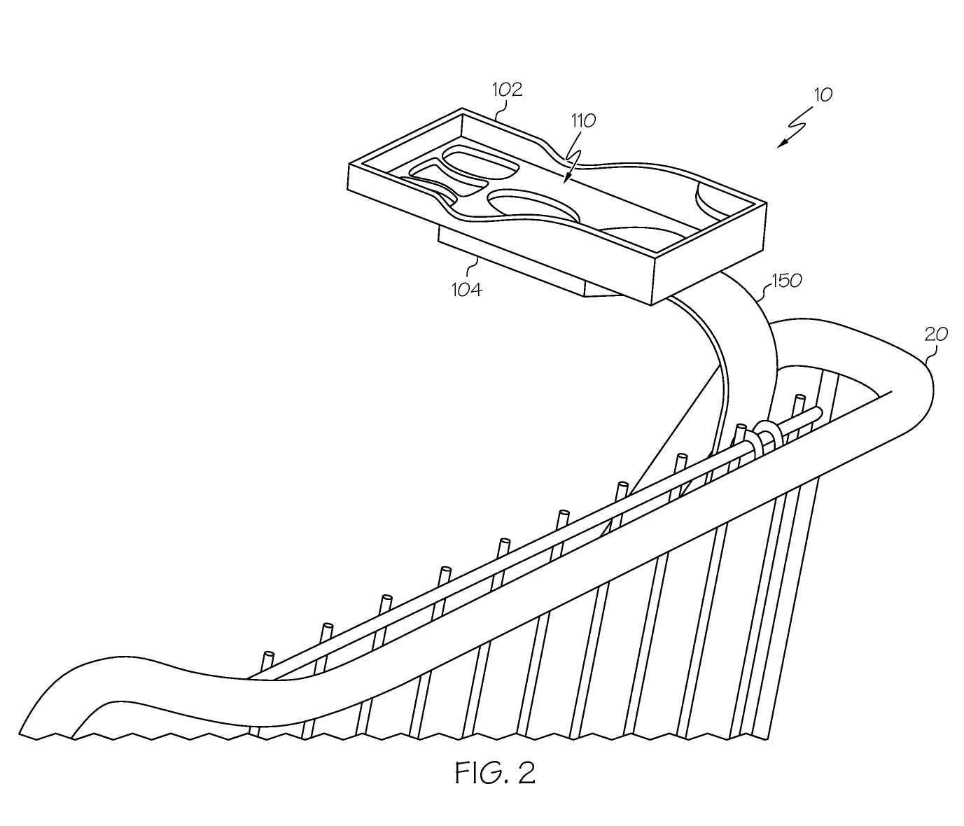

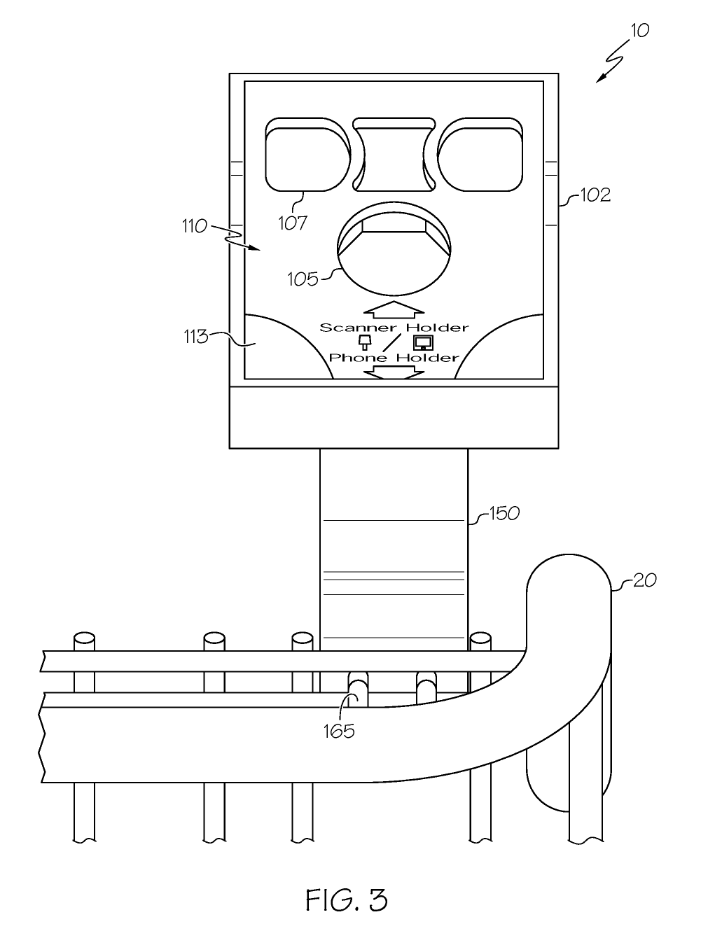

The accessories may also include a set of shield nuts 183 and optional corresponding washers 102 or the like for positioning about connectors 165 such as hooks, or the like, or screws or the like fixedly extending from the backup plate 164, which collectively apply a force about a round tubular rod such as the shopping cart handle 20 when inserted in the gap 162 between the backup plate 164 and the proximal end of the support bracket 150. The proximal end of the support bracket 150 includes holes 153 so that the backup plate screws 165 may be inserted through the holes 153 for forming the gap 162 and securely holding the support bracket 150 in place against the shopping cart 20 or the like. In alternative embodiments, other connectors 165 such as hooks (see FIGS. 2 and 3) may be coupled to the wire caging of the shopping cart. The backup plate 164 is preferably parallel to the support bracket 150 and apply a force in a direction of a distal end of the support bracket 150 when the shield nuts 183 are positioned about the screws 165.

Although not shown, the coupling mechanism 112 may include a tension spring, axle, clamping jaws, hinges, fingers, and/or other mechanical elements for applying a force about a round tubular rod such as the shopping cart handle 20. The clamp or other securing component on the list holder may include a rubber coating to better secure it.

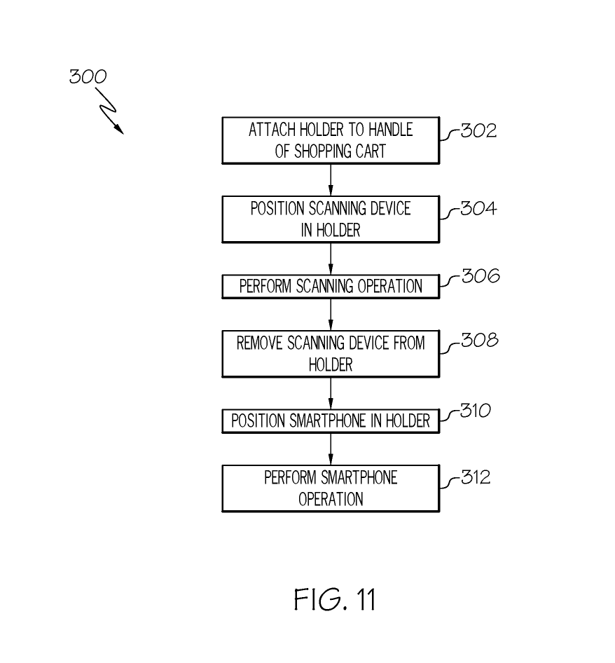

FIG. 11 illustrates a method 300 of coupling two different mobile computing devices to a shopping cart, in accordance with some embodiments. The method 300 may include the mobile device holder 10 and/or other mobile device holder in accordance with other embodiments. Although the steps of the method 300 described with reference to FIG. 9 are presented in the order described, embodiments of the method 300 may be performed out of order and/or performed before or after the order described below. The method steps are constructed for easy and simple installation by a store associate, and for easy and simple use by a store customer or other user of the shopping cart or basket to which a mobile device holder 10 is removably attached.

In one step (302) of an embodiment of a method 300 for coupling two mobile computing devices to a shopping cart or the like, mobile device holder 10 is attached to a shopping cart handle 20. Although a shopping cart handle 20 is shown, mobile device holder 10 can be coupled to any elongated object such as a rod-shaped handle, wire frame, rod, bar, or rail extending from a shopping cart, basket, or other apparatus for transporting store items. For example, the mobile device holder 10 may have tabs, hooks, clips, a covering with a transparent window, etc. extending into the interior to hold the mobile device in place in the interior region 110 of the holder 10.

The mobile device holder 10 is positioned on the shopping cart in a manner that maximizes the use of the shopping cart area. This is due to the holder 10 extending from a basket area, handlebar, wire frame, or other peripheral region of the shopping cart, and not extending into the interior of the shopping cart where groceries or other items are transported by the shopping cart. Similarly, the location of the holder 10 on the shopping cart does not interfere with use of the cart.

The mobile device holder 10 is preferably oriented on the shopping cart, for example, rotate about the handle 20, so that the interior region 110 of the frame portion 102 faces a user of the shopping cart, so that the user can view a display of an electronic device positioned in the holder 10. Also, in some embodiments, the first opening 105 and/or a second opening 107 of the holder 10 may permit a wire, such as a universal serial bus (USB) cable, power cord, and so on to extend between the electronic device in the holder 10 and an external power source, computer device, and so on that is part of, coupled to, or otherwise located in another region of the shopping cart. Thus, the mobile device holder 10 is preferably oriented to allow the wire, cable, or the like to extend from the electronic device in the holder 10 to the external power source, computer device, and so on.

The mobile device holder 10 may also be oriented on the shopping cart so that a store item may be positioned under the second window 107 in order to establish a direct line of sight with a camera, sensor, or input/output device of the electronic device, e.g., scanner 12 or smartphone 14, positioned in the holder 10.

In another step (304), a scanning device 12 may be positioned in the mobile device holder 10. The handle 24 extends through the first opening 105 in the interior region 110 of the frame portion 102. In some embodiments, the scanning device 12 includes a battery cover 26 or the like that is part of or coupled to the handle 24, and which likewise extends through the first opening 105. The scanning device 12 may include a scan window that is positioned over the second opening 107 so that the scan window has a line of sight through the second opening 107 to communicate with a barcode or the like of a store item positioned under the holder 10, for example.

Also, a user can operate the handle 24 of the scanning device 12 when it is in the holder 10. Also, the user may reorient the holder 10 when the scanning device 12 is in the holder 10 by applying a force to the scanning device handle 24, which in turn causes the holder 10 to rotate at least partially about the shopping cart or other elongated object to which the holder 10 is removably attached in order to position the display 22 at a better angle.

In another step (306), the scanning device 12 may operate to scan a barcode, QR code, or capture an image of a store item of interest, which is positioned by the user under the second opening 107 of the holder 10. Although a scanning operation is described, the scanning device 12 is not limited thereto, and may perform other operations when positioned in the holder 10.

In another step (308), the scanning device 12 may be removed from the holder 10 for example, inserting fingers through an opening 105, 107, and/or 109. At step (310), another electronic device such as a smartphone 14 or the like may be positioned in the mobile device holder 10. The smartphone 14 may have a different configuration than the scanning device 12, for example, different width, length, and/or depth, no handle, and so on, but may nevertheless be positioned in the interior region 110 of the holder 10. In some embodiments, step 308 is not performed, but the holder is nevertheless capable of receiving and holding a different mobile electronic device than the scanning device 12.

In another step (312), the smartphone 14 may perform an operation when positioned in the holder 10, such as scanning, point of sale, and so on. When performing a scanning operation, the smartphone 14 may have a camera or other sensor at a surface opposite a display surface so that a user may view from the display a field of view of the camera or other sensor through the second opening 107 of the holder 10.

The embodiments and examples set forth herein were presented in order to best explain the present invention and its practical application and to thereby enable those of ordinary skill in the art to make and use the invention. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination.

What is claimed is:

1. An apparatus for holding two different mobile devices on a shopping cart, comprising:
a frame portion that extends horizontally and includes a perimeter that forms an interior region for receiving at least one of the two different mobile devices;
a first opening in the interior region for receiving a handle of one of the two different mobile devices;
at least one second opening for providing a line of sight view from a sensor in each of the two different mobile devices;
a base portion that extends from a bottom region of the frame portion; and
a removable coupling mechanism that extends between the base portion, and is constructed and arranged for coupling to a shopping cart.

2. The apparatus of claim 1, wherein the two different mobile devices include a smartphone and a handheld barcode scanner, wherein the handle of the one of the two different mobile devices is part of the handheld barcode scanner.

3. The apparatus of claim 2, wherein the handheld barcode scanner includes the handle received by the first opening in the interior region.

4. The apparatus of claim 1, wherein the frame portion is rectangular, the first opening includes a round or oval hole, and the at least one second opening includes three holes for a combination of line of sight viewing by a scanner of the two different mobile devices and access to the interior region.

5. The apparatus of claim 1, further comprising at least one third opening including a drain hole at an opposite end of the frame portion as the at least one second opening.

6. The apparatus of claim 5, wherein the frame portion includes a sidewall having a first region of a first height aligned with at least one opening, a second region having an indent of a second height aligned with the first opening, and a support edge of a third height than the first and second heights aligned with the at least one third opening.

7. The apparatus of claim 5, further comprising a corner stop positioned over at least a portion of the at least one third opening for holding the mobile devices in place in the interior.

8. The apparatus of claim 1, wherein the coupling mechanism is a universal coupling mechanism, and constructed and arranged for coupling a different apparatus to the shopping cart.

9. The apparatus of claim 1, wherein the coupling mechanism comprises:
a support bracket that extends between the base portion and the shopping cart;
a backup plate parallel to and applying a force in a direction of a distal end of the support bracket; and
a set of threaded elements extending from the backup plate for coupling to the support bracket.

10. An apparatus for holding two different mobile devices on a shopping cart, comprising:
a frame portion that extends horizontally and includes a perimeter that forms an interior region for receiving at least one of the two different mobile devices;
a first opening in a mid-region of the interior region for receiving a handle of one of the two different mobile devices;
a plurality of second openings at one end of the frame portion for providing a line of sight view from a sensor in each of the two different mobile devices;
a plurality of third openings at another end of the frame portion for providing drain holes;
a stop extending from the perimeter over each third opening; and
a base portion that extends from a bottom region of the frame portion for providing a coupling to a shopping cart.

11. The apparatus of claim 10, wherein the two different mobile devices include a smartphone and a handheld barcode scanner, wherein the handle of the one of the two different mobile devices is part of the handheld barcode scanner.

12. The apparatus of claim 10, wherein the frame portion is rectangular, the first opening includes a round or oval hole, and the at least one second opening includes three holes for a combination of line of sight viewing by a scanner of the two different mobile devices and access to the interior region.

13. The apparatus of claim 10, wherein the frame portion includes a sidewall having a first region of a first height aligned with at least one opening, a second region having an indent of a second height aligned with the first opening, and a support edge of a third height than the first and second heights aligned with the at least one third opening.

14. The apparatus of claim 10, further comprising a universal coupling mechanism that is constructed and arranged for coupling a different apparatus to the shopping cart.

15. The apparatus of claim 10, wherein the coupling mechanism comprises:
a support bracket that extends between the base portion and the shopping cart;
a backup plate parallel to and applying a force in a direction of a distal end of the support bracket; and
a set of threaded elements extending from the backup plate for coupling to the support bracket.

16. A method for coupling two mobile computing devices to a shopping cart, each of the two mobile computing devices having a different structural configuration, comprising:
coupling a mobile device holder to the shopping cart; and
positioning at least one of the first mobile computing device or a second mobile computing device in the mobile device holder, the first mobile computing device having a handle, the second mobile computing device having a different configuration than the first mobile computing device.

17. The method of claim 16, further comprising replacing one of the first and second mobile computing devices with the other of the first mobile computing device or a second mobile computing device.

18. The method of claim 16, wherein one and only one of the first and second mobile computing devices is positioned in the mobile device holder.
